(19) United States
(12) Patent Application Publication
(10) Pub. No.: US 2005/0131658 A1
(43) Pub. Date: Jun. 16, 2005

(54) Systems and methods for 3D assembly venue modeling

(76) Inventors: Hsaio Lai Sean Mei, San Francisco, CA (US); Kimberly O'Brien, San Francisco, CA (US)

Correspondence Address: PAUL, HASTINGS, JANOFSKY & WALKER LLP, P.O. BOX 919092, SAN DIEGO, CA, 92191-9092, US

(21) Appl. No.: 10/738,650

(22) Filed: Dec. 16, 2003

(51) Int. Cl. G06F 17/50

(52) U.S. Cl. 703/1

(57) ABSTRACT

A 3D modeling system is configured to generate a 3D model from a plurality of architectural, engineering and construction information related to a physical asset being model. The 3D model is based on component models that are associated with specific geometry, geo-positioning, lighting, acoustics, and other real world features or characteristics. The 3D model can also be turned into a digital asset by associating it with critical information related to the physical asset and storing the 3D model and the associations in a database for retrieval and management of the digital asset.

### BACKGROUND

1. Field of the Inventions

The field of the invention relates generally to 3D modeling and more particularly to generating 3D models corresponding to physical assets and storing the 3D models so that the 3D models can be maintained and used in ways that add value to the physical asset or use thereof.

2. Background Information

3-Dimensional (3D) computer aided modeling has been used to provide a limited virtual tour of a building, establishment, or institution. There are also a whole host of computer aided design (CAD) tools that enable architects and engineers to more cost-effectively plan the construction of a building. 3D modeling can also be used in architectural and other types of design projects.

Unfortunately, conventional 3D modeling techniques are limited. For example, the 3D model is typically static. In other words, if various aspects associated with the modeled object or environment, i.e., the physical asset, change, then these changes cannot typically propagated to the 3D model in an efficient manner so that the 3D model remains an accurate representation of the physical asset. Thus, conventional 3D modeling techniques cannot easily be used to maintain accurate 3D models over the life of the physical asset or a project involving the physical asset.

Further, conventional 3D models are based on a limited number of inputs, which limits their accuracy and further limits their usefulness over time. The limited amount of information used in generating a conventional 3D model also limits the ability to tie the 3D model with the physical asset that it represents in a meaningful manner that can provide value to the physical asset or the management of the physical asset.

In short, 3D models generated using conventional 3D modeling techniques can typically be used for only limited purposes.

### SUMMARY OF THE INVENTION

A 3D modeling system is configured to generate a 3D model from a plurality of architectural, engineering and construction information related to a physical asset being model. The 3D model is based on component models that are associated with specific geometry, geo-positioning, lighting, acoustics, and other real world features or characteristics. The 3D model can also be turned into a digital asset by associating it with critical information related to the physical asset and storing the 3D model and the associations in a database for retrieval and management of the digital asset.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 is a flow chart illustrating an example method for generating a 3D model in accordance with the invention;

FIG. 2A is a flow chart illustrating an example method for generating a component model and metadata and associating it with the 3D model generated using the method of FIG. 1;

FIG. 2B is a flow chart illustrating a more detailed example method for generating a component model and metadata and associating it with the 3D model generated using the method of FIG. 1;

FIG. 3 is a flow chart illustrating an example method for generating a 3D model in more detail;

FIG. 4 is a flow chart illustrating an example method for generating an identifier that is associated with the 3D model generated using the method of FIG. 1;

FIG. 5 is a flow chart illustrating an example method for associating the 3D model generated using the method of FIG. 1 with critical information related to a physical asset;

FIG. 6 is a flow chart illustrating an example method for generating a file name for the 3D model generated using the method of FIG. 1;

FIG. 7 is a flow chart illustrating an example method for using the 3D model generated using the method of FIG. 1 to preview events in accordance with one embodiment of the invention;

FIG. 8 is a diagram illustrating an example digital asset system that can be used to implement the processes of FIGS. 1-7;

FIG. 9 is a diagram illustrating exemplary processes and integration technologies that can be used to create a full 3D model of a real estate property in accordance with one embodiment of the invention.

### DETAILED DESCRIPTION OF THE PREFERRED EMBODIMENTS

The following description is directed to systems and methods for 3D modeling of physical assets, which mirrors physical construction of the physical asset in that both the physical asset and a digital asset are assembled out of components with real properties, such as geometric properties, weight, cost, materials, and location. Once constructed, both the physical and digital asset can be maintained, modified, and viewed. Unlike a physical asset, a digital asset can be virtually constructed and modified leading, e.g., to a more cost effective approach to exploring alternatives in construction and on-going operation. For example, alternative designs and layouts for a new sports venue could be digitally constructed and reviewed in terms of appearance, cost, and schedule, so that decisions could be made regarding physical construction of the venue. In another example, modifications to a performing arts venue could be assessed for the effect on the acoustical properties of the venue. In fact, many “what if” scenarios could be implemented in the digital construction before anything is spent on physical construction using one and the same digital asset.

Additionally, a digital asset can be rendered for a remote viewer. For example, a potential ticket purchaser of a performing arts venue can select a seat and see the performing arts venue from the point of view of the seat in question, even under different lighting conditions and viewing different types of events in the same venue.

An exemplary embodiment of the digital construction process comprises building 3D component models and storing them in a database with associations and information such that the 3D component models can be used to maintain digital assets corresponding to various physical assets. The 3D component modeling phase can include acquiring architectural, engineering and construction information from a variety of sources, and extracting properties from that information that can be used to construct the 3D component models. The term “architectural, engineering and construction information” is intended to refer to information that defines or describes various aspects of the physical asset. The 3D component models can then be constructed from documents or models generated from the architectural, engineering and construction information as described in detail below.

The 3D component models can then be used to construct a digital asset that reflects the present state of the physical asset as well as any changes, real or proposed, in the physical asset, or its characteristics and properties. Various views or aspects of the digital asset can then be rendered for a viewer as required.

For example, a sporting venue can have thousands of seats. In which case, the corresponding digital asset can also comprise thousands of seat components. A viewer can be allowed to preview the view from various seats via a 3D rendering of the view associated with each seat component. At the same time, each seat can be analyzed on how they are constructed and fastened to the floor. Additionally, the cost of each seat can be viewed for project accounting purposes. In another example, an acoustical model of a performing arts venue can be rendered to allow the acoustics to be sampled and tested. Numerous analyses can be made all utilizing the same digital asset.

In the following descriptions, systems and methods for generating digital assets for real estate physical assets are described. It will be apparent, however, that the systems and methods described herein can be applied to a wide variety of physical assets. Moreover, once a digital asset is generated, it can be used for a variety of purposes, some of which are described herein. These applications can include, for example, event planning, event previewing, facilities management, sales and& marketing, brokerage preview systems, digital home manual system, asset management, including space planning and resource allocation, geo-positioned repository system of critical real estate property components and data, insurance applications, city planning, and manufacturing, to name just a few.

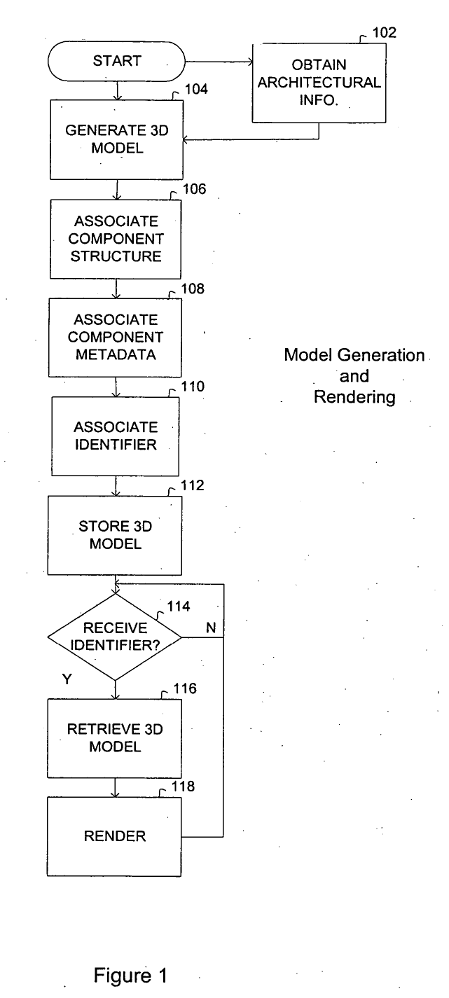

Thus, FIG. 1 is a diagram illustrating an example method for generating a 3D component model in accordance with one embodiment of the systems and methods described herein. It should be noted that in certain implementations, there can actually be several levels of digital building blocks. For example, in one implementation, a 3D component model is any 3D model that is built up from sub-elements, or 3D objects, that are individually named and organized within the overall 3D model. A 3D Object can, therefore, be the smallest geometrical part that together with other 3D objects make up a 3D component model. A 3D component model can specifically be any digital representation of a physical building element that has been manufactured; and a 3D assembly can be any grouping of two or more 3D component models that is referred to in the physical construction process as a single line item. For simplicity, however, a single digital building block, the 3D component model, will be referred to in the description that follows. But it should be understood that a 3D component model can be built up from smaller digital building blocks, e.g., 3D objects, and that 3D component models can be assembled to generate larger digital building blocks, e.g., 3D assemblies.

The process of FIG. 1 begins in step 102 with the gathering of a plurality of architectural, engineering and construction information related to the physical asset being modeled. This can be an important step because unlike conventional systems, the systems and methods described herein can use a wide arrange of inputs to generate models of the physical asset, which can then be integrated to generated a highly representative digital asset. Integration is described in detail below. Thus, the inputs obtained in step 102 can comprise, for example, information from the real estate owner, i.e., the individual or organization that holds the ownership rights to the physical real estate property, or physical asset. The information can also be project based, i.e., any new ground up real estate development or renovation/remodeling of existing real estate that requires planning, design, documentation and/or construction activities.

Survey photos, or drawings, can also be obtained in step 102. These can include, for example, any photographic record or drawing, whether generated manually or by computer, that describes a physical space or property with precise measurements and that records the specific settings of the photographic or measuring device. This includes both on-ground surveys as well as aerial and satellite based photographic imaging. A photographic or measuring device can include traditional as well as digital cameras or video equipment. Survey documentation further includes precise geo-positioning of key features of the physical asset, in order to describe the asset's unique position on earth.

Architectural documents can also be obtained. These documents often include documents generated by a registered professional or organization engaged in the planning, design, specification, and documentation of real estate projects. For example, architects produce, as part of standard practice, a variety of documentation and 3D models to analyze and communicate design solutions; however, the documentation and 3D models are not configured to be integrated into a full building model. This type of documentation can include, for example manual and CAD drawings, specifications, schedules, and renderings.

Structural documentation can also be obtained in step 102. This type of documentation can include, for example, documentation generated by any registered professional or organization engaged in the planning, design, specification, and documentation of the structural components of a real estate projects. Structural Engineers, for example, produce as part of standard practice a variety of documentation and 3D models to analyze and communicate design solutions.

Documentation related to the electrical, mechanical, and plumbing features can also be obtained in step 102. For example, any registered professional or organization engaged in the planning, design, specification, and documentation of the mechanical systems, e.g., Heating, Ventilation, and Air Conditioning (HVAC) systems, electrical systems, and/or plumbing systems of a real estate project can generate documents that can be used as described herein. These types of professionals often produce, as part of standard practice, a variety of documentation and 3D models, e.g., to analyze and communicate design solutions.

Any registered professional or organization engaged in the planning, design, specification, and documentation of the interior design and/or the finishes, furniture and equipment (‘FF&E’) components of a real estate project can also generate documentation or information that can be obtained in step 102 and used as described herein. Interior designers, for example, produce as part of standard practice a variety of documentation and 3D models to analyze and communicate design solutions.

Information related to the landscape can also be obtained in step 102. For example, any registered professional or organization engaged in the planning, design, specification, and documentation of the landscape components of a real estate project, including any topographical changes, planting plans, site furniture and lighting, and environmental graphics, can produce useful documentation or generate useful information. Landscape Architects, for example, produce as part of standard practice a variety of documentation and 3D models to analyze and communicate design solutions.

In addition, a variety of other consultants can participate in a real estate project, including, civil engineers, transportation and traffic engineers, conveying systems consultants or engineers, life, safety, and security analysis consultants or engineers, Information Technology (IT) professionals, graphics consultants, lighting, acoustics and Audio/Visual (A/V) consultants or engineers, asbestos abatement specialists, and water feature consultants, to name just a few. All such consultants produce as part of standard practice a variety of documentation and 3D models to analyze and communicate design solutions that can be obtained in step 102 and used as described herein.

Any registered professional or organization engaged in the oversight and construction of one, unique instance of a physical real estate project, based on the contract documentation provided by an aggregate team of consultants, such as those described in the previous paragraphs, can produce, as part of standard practice, documentation related to schedules, quantity take-offs, accounting reports, shop drawings, and construction progress reports, as well as documentation related to the installation and construction of all building component and assemblies. All such information and documentation can be obtained in step 102 and used as described herein. This information can also include information produced by various sub-contractors. For example, any registered professional or organization engaged in the construction of one, unique instance of a physical real estate project, based on the contract documentation provided by an aggregate team of consultants, such as those described in the previous paragraphs. A sub-contractor normally reports to a primary contractor and delivers schedules, quantity take-offs, shop drawings, construction progress reports, and as-built documentation, in addition to information related to the installation and construction of building components and assemblies.

Manufacturers can also produce documentation or information that can be obtained in step 102 and used as described herein. For example, any qualified professional or organization engaged in the production of building materials and components can produce information based on which 3D components can be constructed which will together make up the digital asset. In addition to delivering the physical materials and/or products, a manufacturer as part of standard practice delivers specifications, photographs, and detailed drawings of their physical products. Manufacturers can also provide additional information about how their products could or should relate to complementary products.

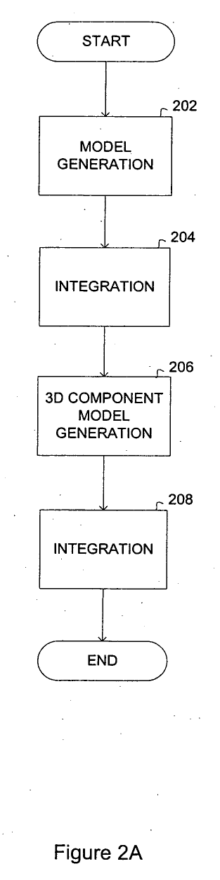

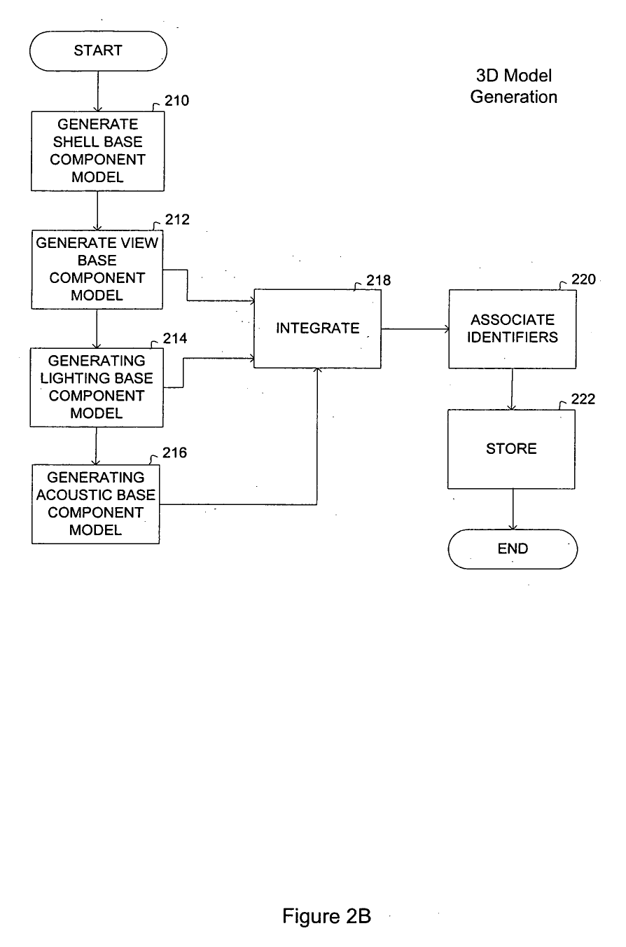

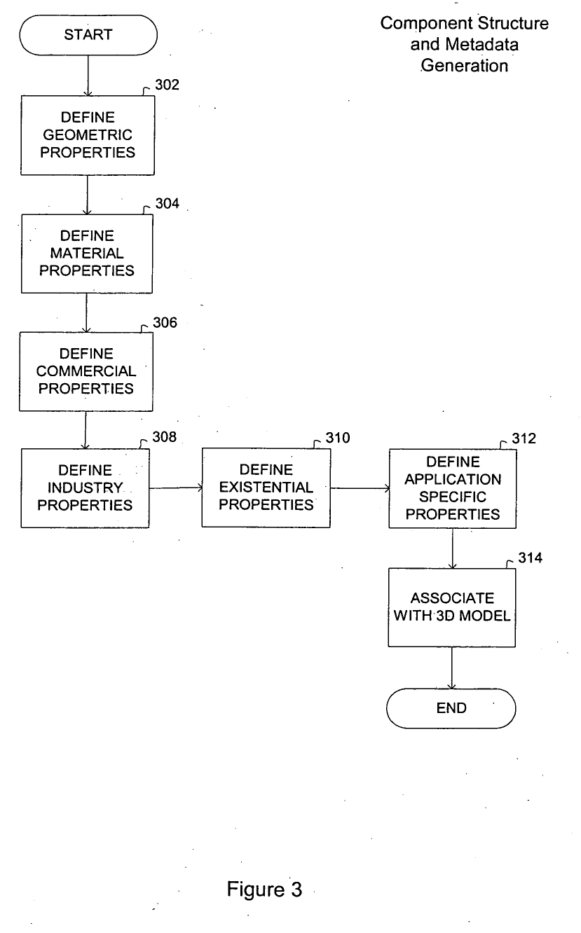

Once architectural, engineering and construction information is obtained in step 102, it can be used to generate 3D component models in step 104. This process is described in more detail in relation to FIG. 2. In order to generate a digital asset from the 3D component models generated in step 104, certain information can be associated with the 3D component models. For example, in step 106 component structure can be associated with the 3D component models, and in step 108 component metadata can be associated with the 3D component models. An exemplary process for associating component structure and component metadata with 3D models generated in step 104 is described in more detail in relation to FIG. 3.

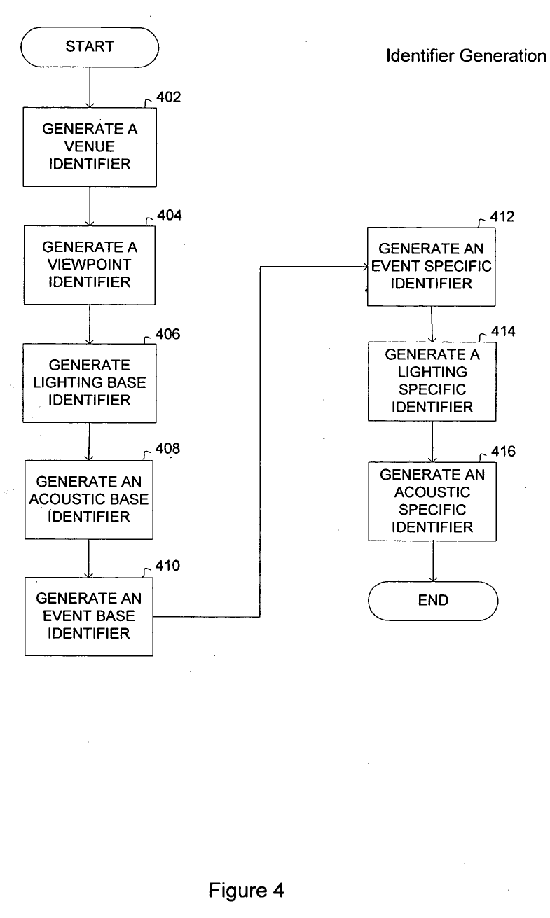

In step 110, an identifier can be associated with a 3D component model generated in step 104, and the 3D component model can be stored in step 112. An exemplary process for generating and associating an identifier is described in detail in relation to FIG. 4.

Next, in step 114, the identifier can, for example, be used to search and select a 3D component model, or models, in order to achieve some intended functionality. If the identifier is selected in step 114, then the appropriate 3D component model, or models, can be retrieved in step 116 and rendered accordingly in step 118. For example, if the 3D models are used to preview view points for an event, e.g., the view from a particular seat, then the identifier can be configured to identify a selected viewpoint, and the 3D models retrieved in step 116 and rendered in step 118 can be used to illustrate, in 3-dimensions, the view from the selected view point.

FIG. 2A is a flow chart illustrating an exemplary process for generating a 3D component model in accordance with one embodiment of the systems and methods described herein. As can be seen, the process illustrated in FIG. 2A comprises two integration steps 204 and 208. These two integration processes serve to build up a 3D component model, but can involve different types of integration. Thus, in step 202, various models are generated from the information gathered in step 102. The models are then integrated, in step 204, in order to generate, in step 206, accurate, meaningful, and useful 3D component models related to a certain physical asset. Then, in step 208, the 3D component models can be integrated in order to generate a geo-positioned, unique digital version of the physical asset.

The models generated in step 202 can include, for example, several software/computer generated models. In other words, the systems and methods described herein do not necessarily make use of any single software application or suite of software applications in the development of a geo-positioned, unique 3D components model that is useful for the complete life cycle of, e.g., a real estate property. Thus, the systems and methods described herein can make use of an integrated model based on several different underlying models, which are integrated in step 204.

One type of model, for example, can be generated using a CAD solution, which can generally be defined as a design and drafting software function that is capable of accurately describing the geometry of real world object for the purpose of communicating construction geometry and method of assembly. These types of solutions provide for digital documentation of the geometric properties of objects and typically position objects relative to each other using insertion points as basis for relational positioning.

Another type of model can be generated using a 3D solution, which is typically a solution that is capable of describing real world geometries including a third dimension, e.g., as solid models. Such solutions can be capable of performing Boolean operations, which allow for the creation of complex solids. As with the CAD solution, 3D software solutions currently provide for digital documentation of the geometric properties of objects and typically position objects relative to each other using insertion points as basis for relational positioning.

Photo modeling solutions, which allow for the creation of solid 3D geometries from photographs, in the absence of any CAD or manually generated documentation, can also be used to generate models in step 202. Photo based modeling can, for example, be based on perspectival science. If a field of view is known and one dimension within the photograph is accurate, then all geometric dimensions can be related to that dimension and, therefore, the entire environment can be extrapolated. In the case of a photographic camera the focal length setting determines the field of view. For example, a focal length of 55 mm is ideal as that is both a standard type lens as well as the closest approximation of the human eye. A photo modeling solution can also be used to capture the image of materials and surfaces of real world objects.

Graphics solutions can also be used to adjust the visual accuracy of real world materials and finishes. The resulting corrected material images can form the basis of visual material maps that can then be applied to the 3D components.

Photometric solutions can be used to apply real world lighting characteristics as defined by the Illuminating Engineering Society (“IES”) to light fixture components within the 3D component model. The process of calculating the actual light distribution within a 3D environment can be based on various techniques. For example, one technique, called ray-tracing, traces the light emitted from a source and tracks it until it bounces against another solid, at which point the ray is processed. The object's material properties such as absorption/reflectivity can then be used to further trace the ray until it bounces against another solid object. This method is typically ‘demand-driven’ in that the light rays are only calculated after a view has been established and, therefore, all angles of polygons defining the associated 3D environment are known, allowing for the ray-tracing to occur.

Another technique is called radiosity, which is a ‘data-computational’ method of light calculation. Radiosity is based on preset intensity and material specifications of each object within the environment being modeled. With this information, the effect of light sources on each object can be calculated, as well as the light and color impact due, e.g., to the proximity of two objects.

Another technique that can be used is global illumination. This technique takes into account not only the light coming directly from light sources, but also the reflection of any light off of any surface in the entire 3D component model.

Laser/Light scanning can also be used in step 202. This type of method uses lasers, or some other photographic light based technology, to scan real world objects to develop an integrated solution of geometric description of a 3D object and its associated material image map. Various levels of accuracy can be achieved depending on the specific technology as required by a particular implementation.

A Global Positioning System (GPS) solution can be used to identify a specific digital point in a 3D component model as being precisely positioned as a unique instance on earth. Such a solution can also be used to mark the specific period of time that that 3D component model is located in such position.

A metadata editor can be used to add, edit, and manage non-geometric or tabular data that has been associated with 2D or 3D geometric descriptions of 3D objects. Such an editor can be used, for example, to link a 3D component model to other types of applications including databases, cost estimating, project management, and scheduling software.

A physical construction methodology can also be used in the integration process of step 204. This refers to the complete set of processes and resources required in order to physically build a specific real estate property on a particular location on earth. Such a methodology can be dependent on the material and handling specifications intrinsic to the material and as described by the manufacturer(s) of that material.

The tools, techniques, and solutions described in the preceding paragraphs can be used to generate models, or other structures or data that can then be integrated in step 204 to generate geo-positioned, 3D component model that can be further used as described below.

For example, FIG. 2B is a flow chart illustrating a slightly more detailed process of generating 3D component models (step 206) and integrating them (step 208) into a single multi-aspect 3D component model. Thus, in step 210-216, a plurality of 3D component models are generated based on the information gathered in step 102. These component models can include a shell base component model (step 210), a view base component model (step 212), a lighting base component model (step 214), and an acoustic base component model (step 216). Examples of these types of models are discussed more fully below. The 3D component models generated in steps 210-216 define different aspects of the physical asset being modeled. They can then be integrated in step 218 to generate a composite 3D component model in step 218. The integrated 3D component model can then be associated with an identifier, in step 220 and stored in step 222.

As described above, when a 3D component model is stored (step 112) it can be stored with associated component structure and metadata information. The flow chart of FIG. 3 illustrates an exemplary method for associating this type of data in accordance with one embodiment of the systems and methods described herein. Each 3D component model has the following core properties associated with it independent of the use or installation of the physical component. These core properties should be supplied at the time of the 3D component model's creation. If certain core properties are not known at the time of creation, an assumption can be made and tagged as being unconfirmed.

First, in step 302, geometric properties are defined for the 3D component model. The geometric properties can comprise, for example, simple or Boolean x, y, and z dimension(s) volume, and center of gravity, to name just a few. The exact geometric properties used will depend on the specific implementation and can include some or all of the above as well as other properties not expressly listed.

In step 304, material properties are defined for the 3D component model. Material properties can include base material type, weight, texture, conductivity, impact resistance, opacity, reflectivity, and (in)compatibility with other materials, to name just a few. Again, the exact material properties used will depend on the specific implementation and can include some or all of the above as well as other properties not expressly listed.

Next component metadata can be defined and associated with a 3D component model. Component metadata refers to those properties that describe the 3D component model's specific use in a real estate project. Unlike the core properties, the metadata property fields can be adjustable and do not necessarily need to be supplied at the time of creation; however, over time, as each field is populated, the 3D component model can become more useful and can increase in value for the owner of the physical asset in which the actual physical component is installed.

Thus, in step 306, commercial properties can be defined for the 3D component model. The commercial properties can include cost of material, cost of installation, lead time, availability, manufacturer's contact information, purchase date, warranty length, warranty limitation, and anticipated replacement timeframe. Again this list is not necessarily exhaustive and can change depending on the particular implementation.

In step 308, industry properties can be defined for the 3D component model. The industry properties can include an indication of a responsible discipline, e.g., architecture, interior, structural, mechanical, electrical, plumbing, data/communication, life safety and specialty, etc., and specification standard numbering, to name a few.

In step 310, existential properties can be defined for the 3D component model. The existential properties can include insertion/origin point, GPS position of insertion/origin point, latitude, longitude, altitude, and collision detection. In step 312, application specific properties can also be defined for the 3D component.

It should be noted that, as indicated, none of the preceding lists of various properties that can be defined are intended to necessarily be exhaustive and that the actual lists of properties can change depending on the implementation. The properties that are defined in steps 302-312 can then be associated with a 3D component model in step 314.

FIG. 4 is a flow chart illustrating an example method for associating an identifier with a 3D component model in accordance with the systems and methods described herein. An identifier can be used to identify an aspect, such as a particular view point associated with the digital asset. By using identifiers to identify aspects of interest, the identifiers can then be used to retrieve the appropriate 3D component models and to render them in a meaningful manner.

Thus, for example, in step 402 a venue identifier can be associated with a 3D component model. The venue identifier can be used, e.g., to identify the physical asset. In step 404, a view point identifier can be associated with the 3D component model. The view point identifier can be used to identify certain locations and views associated with the venue. As explained below, the view point can, for example, correspond to the view associated with a particular seat at an event venue. Thus, the identifier as built in step 402 and 404 can identify the particular venue and the particular view of interest.

For venues where the lighting is of interest, a lighting base identifier can be associated with the 3D component model in step 406. The lighting base identifier can be used to identify a lighting base component model that is associated with a particular venue and/or view point. Similarly, an acoustic base identifier can be associated with the 3D component model in step 408. The acoustic based identifier can be used to identify an acoustic base component model that is associated with a particular venue and/or view point.

If in fact an event is associated with the venue, then an event base identifier can be associated with the 3D component model in step 410. Thus, the venue, event, and a view point of interest can be identified by the identifier constructed according to the method of FIG. 4. In addition, if there is relevant lighting or acoustics normally associated with the venue and/or view point, then these too can be identified. The identifier can allow a 3D component model to be retrieved and rendered in a manner that illustrates relevant features of the digital asset as identified by the identifier.

If there is specific information related to a particular event, then an event specific identifier can be generated and associated with the 3D component model in step 412. In addition, a lighting specific identifier and/or an acoustic specific identifier associated with the specific event can also be generated and associated with the 3D component model in steps 414 and 416 respectively. These identifiers can be used, for example, to identify 3D component models that are based on event, lighting, and/or acoustic information gathered for a specific event.

An example embodiment that can be used to preview seats for an event is described in detail below; however, it should be noted that the process of generating an identifier that identifies the various 3D component models of interest can be generated based on a variety of factors, or aspects of interest.

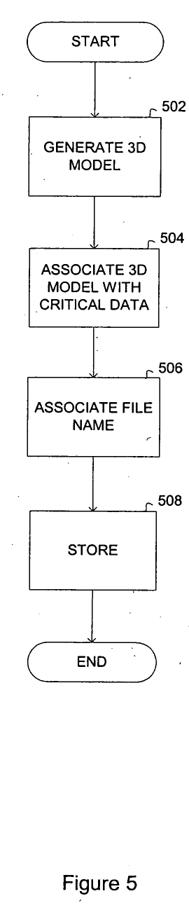

In another embodiment, a library of 3D component models can be maintained with relevant associations to form digital assets that can be managed as described herein. Thus, filenames that specify relevant associations and information can be generated for each 3D component model as they are saved. Additionally, the files can be linked with critical data associated with the corresponding physical asset in order to maximize the value of the digital asset. The flow chart of FIG. 5 illustrates an example method for storing a 3D component model in accordance with one embodiment of the systems and methods described herein.

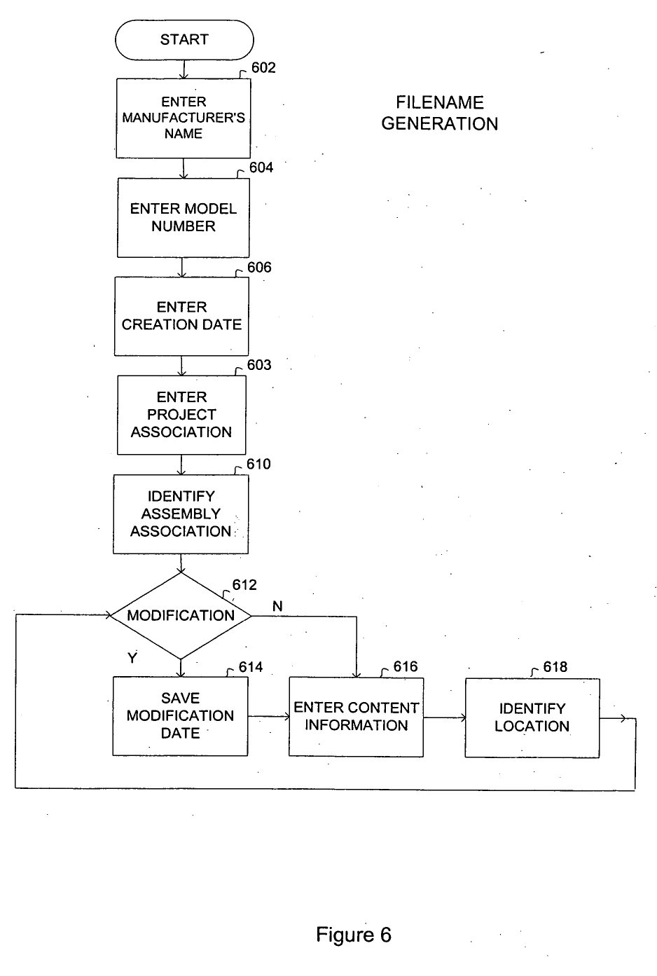

In step 502, a 3D component model is first generated. The generation of the 3D component model can, for example, be in accordance with the systems and methods described above. In step 506, a file name is associated with the 3D component model. File name generation is described in detail with respect to FIG. 6 below. In step 506, the 3D component model is saved as a file using the file name of step 504. In step 508, critical data associated within the associated physical asset can be linked, or associated with, the file saved in step 506.

FIG. 6 is a flow chart illustrating an example method for generating a file name for a 3D component model in accordance with the systems and methods described herein. The process begins in step 602 after a 3D component model has been generated and is, for example, to be saved. Thus, in step 602, generation of the file name can require that a manufacturer's name be provided. The manufacturer's name can correspond, for example, with the name of the manufacturer of the physical component that corresponds to the 3D component model. In step 604, any model number associated with the physical component can also be provided.

In step 606, the date of original creation of the 3D component model can be determined. This can be done automatically, or the creation date can be manually provided, depending on the implementation. In step 608, a 3D component model project association(s) can then be provided. This information can, for example, identify the corresponding digital asset for the 3D component model. Further, since a particular 3D component model can be used in more than one digital asset, the 3D component model can have more than one project association.

In step 610, any assembly association(s) can be provided. In other words, if the 3D component model is actually used to generate a larger 3D component, i.e., a 3D assembly, then the 3D assembly, or assemblies can be identified in step 610.

In step 612, it can be determined if the information being provided, or determined, is a modification to previous information provided, or determined, for the 3D component model. If it is, then in step 614 the date of modification can be determined, e.g., automatically or manually.

In step 616, contact information for the 3D component model can be provided. For example, the digital architect's name and contact information can be provided in step 616.

In step 618, the file location can be determined. Once all of the fields associated with the file name, e.g., the fields described in the preceeding paragraphs, have been populated, then the 3D component model can be saved as a file in a data base using the file name and along with the associated component structure and metadata information.

The file name information and component structure and metadata associations can, for example, allow for the creation and management of digital assets that correspond to a physical asset. As mentioned, a digital asset is the digital equivalent to the physical asset, i.e., it is the specific and unique collection of objects and data that describes a particular property. A digital asset can be maintained along side the physical asset, and can consist of components that look and behave much like their physical counterparts, but because of the components ability to be linked to critical data associated with the physical asset, the digital asset in many ways is ‘smarter’ and potentially more valuable than the physical asset, as it may survive the beyond the physical asset's existence. Or, in the case when a digital asset has been created for a new physical asset, but in the event that the physical asset is not constructed, then the digital asset will serve as the only integrated instance of the information that was generated to describe the intended physical assets.

A digital asset is the specific combination of 3D component models assembled to create a unique and geo-positioned instance of a specific, physical asset, such as a real estate property or venue. The individual 3D component models that make up a digital asset can be made available to the owner of the physical asset. For example, the owner of the physical asset can own the corresponding digital asset. Alternatively, the architect or creator (“the digital architect”) of the digital asset can own the digital asset and make it available to the owner of the physical asset through a license. It is also possible for the owner to own the digital asset, but for the digital asset to be stored on systems belonging to the digital architect. In which case, the owner can be charged a fee for accessing the digital asset resources on the digital architect's system.

The critical data associated with the files comprising the digital asset can comprise existing documents, such as existing CAD or manually generated documents that are or were, in the case of pre-existing physical assets, being used in the planning, design, construction and operation process of a physical asset project. The documents can, for example, form the basis for input to the process of generating a digital asset for a pre-existing physical asset. For new projects the documents can be the same documents and files that are being generated, e.g., in step 102. In certain embodiments, the documents can be made available for use in the operation and facility management of the real estate property upon its completion.

The library of 3D component models can be a valuable asset in itself. Because of the way the 3D component models are assembled, which is described above, the 3D component models can be easily integrated into the development of a new digital asset. In other words, when a new digital asset is being built much of the process can be bypassed to the extent that a new digital asset makes use of digital components that have been modeled in the past. Thus, for example, if the owner of a real estate property is in the process of building a new real estate property and wants to model solutions and options using a digital asset for the new physical property, then the owner could save time and money by reusing much of the same components that were used to generate a digital asset corresponding to the first real estate property.

The 3D component models in the 3D component model library, therefore, can actually have a value and use that is not tied to the digital asset with which they are associated. Thus, the digital architect can actually license or sell 3D component models to new clients and thereby generate further revenue from the 3D component models.

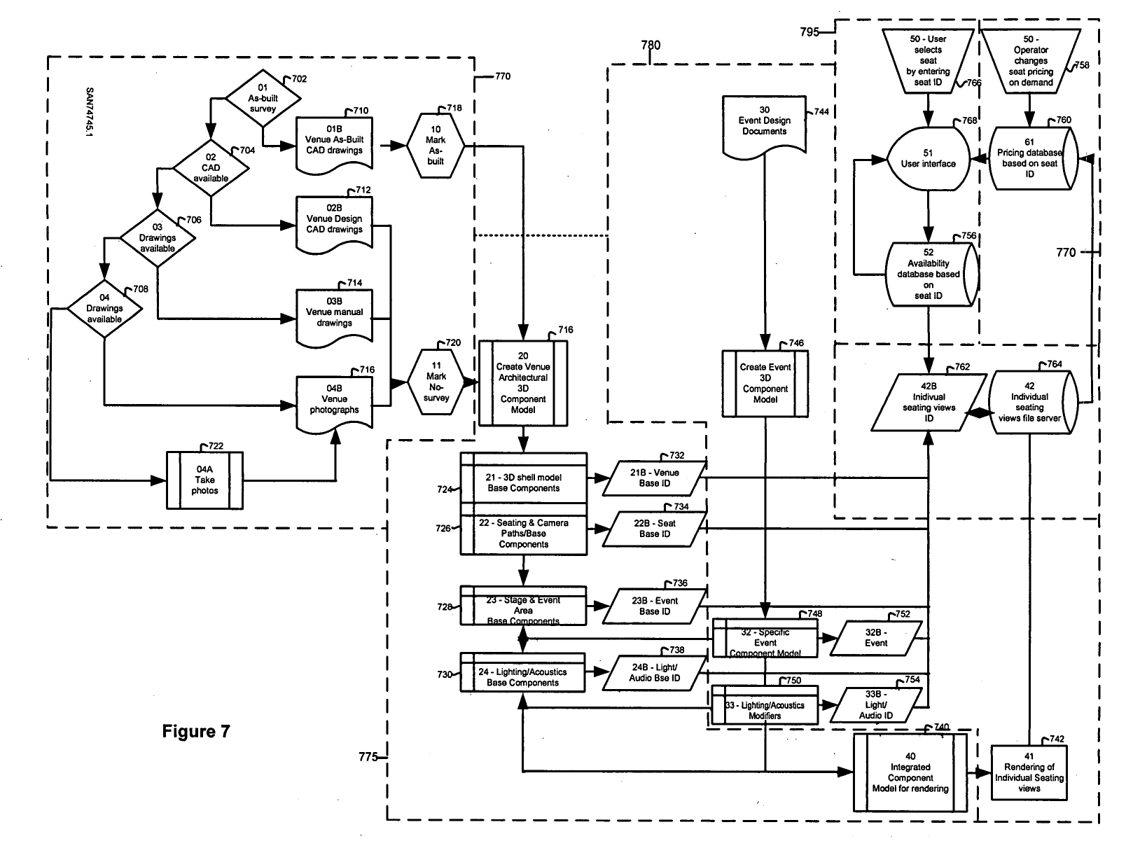

3D component models and digital assets generated in accordance with the systems and methods described above can be used for a variety of purposes. In one embodiment, for example, the 3D component models can be used to preview view points for events at a specific venue, such as a stadium or concert hall. FIG. 7 is a flow chart illustrating an example method for previewing view points using 3D component models generated as described above. The method of FIG. 7 can further be used to implement dynamic pricing for tickets, or seating to an event being previewed.

Thus, the flow chart of FIG. 7 illustrates full featured 3D component based modeling that documents all visible elements within an assembly venue for the specific purpose of providing pre-views of the stage or event areas from every single view point, e.g., seating location. The 3D model can allow for the insertion of various events or performances in the venue under different lighting and sound conditions. The ability to provide views from, e.g., every single seat, can also allow for individual seat pricing and individual price adjustments per seat based on demand including bid situations.

The term “assembly venue” can be used to mean any existing, new, or planned physical real estate property that can be used for presentations, performances, and events. These venues can include, but are not limited to, stadiums, arenas, theatres, auditoriums, exhibition centers, amphitheatres, etc.

The process of FIG. 7 can begin, therefore, with the gathering of architectural information describing the assembly venue in sub-process 770. First, it can be determined, in step 702, if as-built survey information of the assembly venue is available, i.e. if there are surveyed drawings and other documents available of the existing condition of a given assembly venue. If so, then the venue as-built survey information, which can include CAD drawings, can be obtained in step 710 and can form the basis for the 3D modeling to follow. Any as-built information can be marked “As-Built” in step 718 as can any 3D component models generated therefrom. The as-built information typically represent the most accurate level of information.

If as-built information is not available, then other architectural, engineering and construction information can be obtained. For example, in step 704 it can be determined if any venue design CAD drawings are available, which can include design drawings or construction drawings. If so, then the venue design CAD drawings can be obtained, in step 712, and used to form the basis for the 3D modeling that follows. The venue design CAD drawings typically represent the second most accurate level of information. The venue design CAD drawings, as well as the 3D component models generated therefrom, can be marked “No-survey” in step 720 to indicate that they are not based on as-built information.

If venue design CAD drawings are not available, then it can be determined in step 706 if any prints or other manually produced sketches are available, which may include historical blueprints for example. If so, then in step 714, such venue manual drawings can be obtained and used to form the basis for the 3D modeling that follows. Such venue manual drawings typically represent the third most accurate level of information. The venue manual drawings, and the 3D component models generated therefrom, can also be marked “No-survey” in step 720 to indicate that they are not based on as-built information.

If venue manual drawings are not available, then it can be determined, in step 708, if any photographs of the venue are available. If so, then the photographs can be obtained in step 716, and used to form the basis for the 3D modeling that follows. In this case, at least one accurate dimension taken from the actual venue can be required for modeling purposes. Such venue photographs typically represent the lowest level of accuracy. The venue photographs, and the 3D component models generated therefrom, can also be marked “No-survey” in step 720 to indicate that they are not based on as-built information.

If no venue photographs are available, then venue photographs can be obtained by photographing the existing venue in step 722. Preferably, the photographs will include photographs of the flooring, walls, and ceiling conditions, as well as any structural and other visual obstructions. In addition, the stage or event area can be photographed. At least one accurate dimension taken from the physical structure can still be required for accurate modeling.

Once the architectural, engineering and construction information is obtained in sub process 770, 3D component models can be generated and identified in sub process 780. It should be noted that 3D component models of the assembly venue can be built at any time and from little information; however, the highest quality and accuracy will often be achieved, in the case of an existing venue, if as-built conditions have been documented and are used. If those conditions have not been documented or in the case of new construction cannot yet be documented, then information obtained, for example, in steps 712-716, or photographs obtained in step 722, can be used. In fact, when a venue is new or still in the planning and/or design stage, the 3D component models will often be based on documentation other than as-built documents. But after the venue has been built, or an as-built survey has been conducted, the 3D component models can be updated and marked accordingly.

Thus, in step 716, 3D component models based on the information obtained in sub process 770 can be generated, e.g., in accordance with the systems and methods described above. In the embodiment of FIG. 7, the 3D component models are, for example, subdivided into various levels of 3D component models, of which the highest levels can include a shell base component model, a view base component model, an event base component model, a lighting base component model, and an acoustic base component model.

A shell base component model can be generated in step 724 and can comprise all spatial elements that define the shell of the venue, including all relevant visual attributes including, for example, geometry, material finish, and detail information. Such information can include, for example, aspects including: flooring, which can include any floor slopes and permanent level changes; side walls including all fixed elements, but excluding movable acoustical treatments such as movable sound attenuation, re-direction, and absorption panels; ceiling aspects including multiple ceiling levels; fixed or built-in lighting fixtures or light and A/V armatures, but excluding any movable lighting fixtures and A/V equipment or movable sound attenuation, re-direction, and absorption panels; mezzanines, balconies, and any other level changes in seating that define alternate locations for the audience including any fixed or built-in elevated structures, but, in certain embodiments, excluding any temporary seating arrangements or locations that are specific to short term events; columns, beams, and any other structural members within the visible space that, for example, may obstruct view lines including any architectural or interior design specified treatment or detail that may visually protrude into the space and have a visual impact on the audience's view of the stage and event area; and proscenium or any other structure(s) which frame views of the event areas including any fixed element that frame the stage or event area and that can be used to conceal or contain curtains, but, depending on the embodiment, excluding any temporary stage or event view framing design that is provided specifically for a short term event.

In step 726, a view base component model can be generated comprising all spatial components that define the seating and location of the audience. The view base component model can include, for example, aspects including seating models, such as models of each different seat type used within the assembly venue. This also includes open areas reserved for wheelchair seating. The insertion or reference point of these seats can, depending on the embodiment, be placed at the center of the seat with its vertical location placed at the bottom of the seat supports. The view base component model can also include a viewing cameras aspect. In order to render views from each individual seat, a ‘virtual’ camera can be placed within each seat and a snapshot can be taken from that location to provide highly detailed approximations of the actual view from that seat. The insertion point or reference of the camera can, depending on the embodiment, coincide with the insertion point of the seats. The camera location can, however, be placed above the insertion point to approximate the average eye level of a seated person, i.e., the camera location can be located at approximately 4 feet above the insertion point for the seat.

The view base component model can also comprise seating/camera path aspects, which are geometric 2D paths that describe the layout of the seating arrangements. Such paths can include arcs, lines, and (semi-) circles, with the stage or event area as the focal point. These paths can, for example, be derived from the seating layout plans in sub process 770. Depending on the number of seats along these paths, each node on the path can be the location for the insertion points of the seats and cameras.

In step 728, an event base component model can be generated that can comprise all spatial components that define all permanent elements of the stage and/or event area. This base condition shall be the default condition for audience/seating view generation and can comprise a base stage area including permanent substructure, fixed stage components, and flooring, fixed back-drop/background area, and permanent armatures for attaching or modifying stage backgrounds, but depending on the embodiment, excluding temporary structures or backdrops that are specifically created and inserted as part of temporary or short term presentations, performances, or events.

In step 730, a combined lighting and acoustic base component model can be generated. Alternatively, separate lighting base and acoustic base models can be generated. The combined lighting and acoustic base component model can comprise, for example, all spatial components that define the base or default condition of lighting and acoustics associated with the venue. Thus, aspects that can be included can comprise all moveable and/or adjustable lighting fixtures, moveable and/or adjustable A/V equipment speakers that are individually visible, television or other media camera equipment, specialty lighting that can potentially obstruct views, and electrical and A/V outlet locations that impact the layout and staging of events.

The 3D component models can be integrated and stored in step 740 for later retrieval. Example embodiments of integration and storing are described above.

In steps 732-738, sub-component models that are part of the selection criteria in a user defined selection of seating views are assigned an identifier that acts as one of the parameters for user defined queries. User selection and user defined queries are described in detail below. The identifiers assigned in step 732-736 can be combined in step 762 into a user selectable identifier. The user selectable identifier, generated in step 762, can comprise several data fields including a name of the venue, address and geo-positioned location of the venue, telephone number associated with the venue, or any other uniquely assigned data that helps to separate this venue from others. These types of fields can be part of a venue identifier assigned in step 732 to the shell base component model generated in step 724.

In addition, a seat base identifier can be assigned, in step 734, to the view base component model generated in step 726. The view base identifier can comprise a unique identifier that helps to locate a particular seat based on a seating layout. This identifier can, for example, comprise the seat number and can also contain data fields that include a section, area number, area name, and/or a row number.

An event base identifier can be assigned, in step 736, to the event base component model generated in step 728. The event base identifier can, e.g., refer to the default condition of the stage and/or event area. For example, in a football stadium, the default condition can show the football field as it exists in the default condition without any event, i.e., a football game, taking place.

In step 738, a light/acoustic base identifier can be assigned to the combined lighting and acoustic base model generated in step 730. The lighting acoustic base identifier can refer, for example, to the default condition of the lighting, acoustics, and A/V setup. For example, in a Broadway theatre the default condition can be when the lights in the theatre are still turned on at the beginning of a performance.

Event specific information can be included in sub process 780. For example, in step 744 event specific design documents can be obtained and used to generate 3D component models for the specific event. Event specific design document can include, for example, design and layout documents for the setup of the stage and/or event area for a specific event, e.g., a unique backdrop design can be documented in design drawings, elevations, and sketches. These types of documents can be obtained in step 744 and used to generate 3D event specific component models that can be integrated, in step 740, with the 3D component models generated in steps 724-730.

Specifically, an event specific component model can be generated in step 748 and can comprise components that are specified in the event design documents as being required for a specific event to take place. This can include, for example, stage sets, props, and any other staging element that can visually impact the audience's views or that may create visual obstructions.

In step 750, a lighting and acoustic specific component model can be generated comprising any adjustments in the lighting and acoustic base component model generated in step 730. For example, the lighting and acoustic specific component model of step 738 can include acoustical and A/V components that are geared towards a specific event and can include revisions to lighting settings per the event design documents. Any necessary equipment for the performance that can have a visual impact on various seating views can be included.

The event specific component models generated in steps 748 and 750 can also be assigned identifiers that can be combined, in step 762, with the identifiers generated in steps 732 to 738. For example, the event specific component model generated in step 748 can be assigned an event specific identifier in step 752. This identifier may include data fields for event name and date(s). Additionally, a light/acoustic identifier can be assigned, in step 754, to the lighting and acoustic specific component model generated in step 750. This identifier can refer to the specific lighting, acoustics, and A/V setup for the specific event.

As mentioned, in order to render the individual views from each seat, the models of the base conditions generated in steps 724-730 should be combined with these of the specific event generated in steps 748 and 750. This combining can occur in the integration process of step 740.

Individual seating views can then be rendered in step 742. The rendered views can, depending on the embodiments, be static images, e.g., directed towards the stage and event area, or they can be semi-panoramic interactive views from each seat that, e.g., allow a user to pan around the view from a prospective seats. All rendered views can be stored, in step 750, on a file server from where a user interface application can be configured to pull the appropriate view depending on a selection and as determined by a query generated from the user interface.

In sub process 785, a view point can be selected and the associated view from the select view point, or seat, can be previewed via the associated rendered view. Thus, in step 752 a user, or prospective purchaser, can select a seat, e.g., by entering a seat identifier into a user interface. For example, in one embodiment, the user can enter the appropriate seat number including section, area, and/or row and find the seat as well as the associated view. In another embodiment, the user can select from an interactive map, linked by identifier to the same seat.

The user interface can also be configured to allow the user to select specific events as well as the views under specific light and acoustical conditions. The User can also be allowed to run queries for multiple seats.

Thus, depending on the user input received in step 766, the user interface will generate a query and/or retrieve the associated view in step 768. In step 756, an availability database can be configured to update the availability of the seat selected by the user. For example, after a user has purchased a seat, a corresponding field in the availability database can be updated to show the seat as being taken. This can trigger a visual feedback in the user interface showing the seat requested as being taken, e.g., in a highlighted graphic representation.

The availability database can, in certain embodiments, be linked to an external ticket sales solutions. This can, for example allow and operator to change, in step 758, seat pricing on demand. In other words, the operator can adjust ticket pricing based on the event and on-going demand for tickets. Alternatively, a formula based approach can be implemented to automatically adjust prices, e.g., when certain sales milestones are surpassed. The exact formula will, of course, vary, depending on the particular implementation. Thus, for example, a pricing database, e.g., based on seat identification, can be linked to both the views database as well as the availability database. As seats are purchased, the pricing database can be updated in step 760 to reflect new pricing as appropriate.

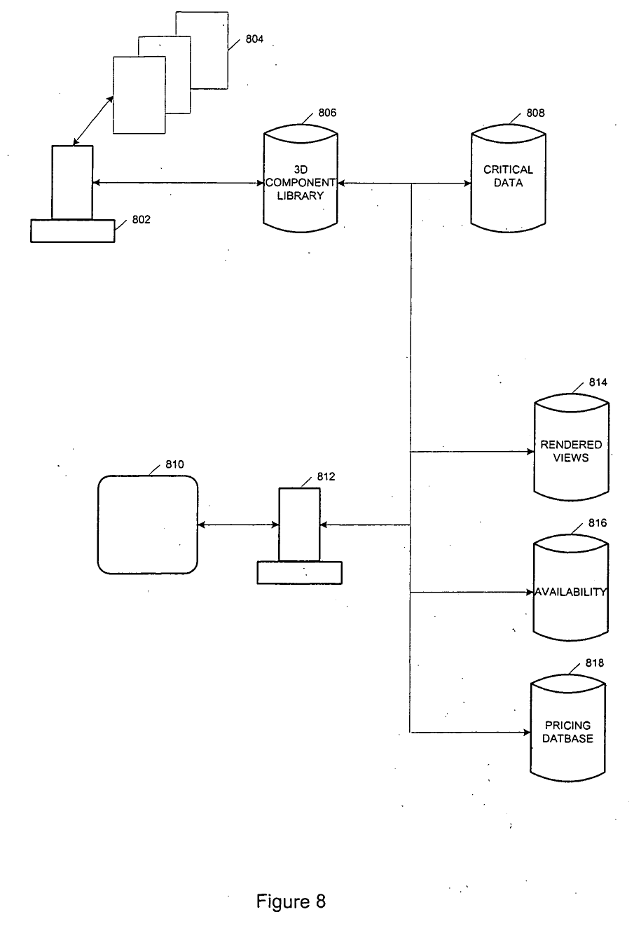

FIG. 8 is a diagram illustrating an exemplary 3D component modeling system 800 configured to implement the methods described herein. System 800 can comprise a model generation authority 802 configured to receive architectural information and to generated 3D component models therefrom. Thus, in one embodiment, model generation authority 802 can be configured to run a plurality of applications 804, which are capable of generating the models described above in relation to, e.g., step 202. Model generation authority 802 can be configured to then integrate the models to generate 3D component models, as described above, which can then be stored in a 3D component model library 806 interfaced with model generation authority 802.

The term “authority” used to identify model generation authority 802 is intended to indicate the computing systems, hardware and software, associated with model generation authority 802. Thus, depending on the embodiment, the term authority can refer to one or more servers, such as Internet or web servers, file servers, and/or database servers, one or more routers, one or more databases, one or more software applications, one or more Application Program Interfaces (APIs), or some combination thereof. Further, the computing system associated with model generation authority 802 can include one or more computers or computer terminals.

The various applications 804 can, depending on the embodiment, be configured to run on a plurality of separate servers or computer systems. In which case, model generation authority 802 can be configured to receive the output of programs 804 and to integrate them as required to generate the appropriate 3D component models. Model generation authority 802 can also be configured to receive file name information and to store the 3D component models as files in 3D component library 806 using a file name generated from the file name information as described above.

Additionally, model generation authority 802 can be configured to generate component structure and metadata and to associate and store it with the 3D component models as described above. Alternatively, model generation authority 802 can be configured to receive component structure and/or metadata, generated on a separate server or system, and then to associate and store it with the 3D component models.

System 800 can also comprise a critical data database comprising data and information related to one or more physical assets being modeled by system 800. Thus, model generation authority 802 can be configured to associate the critical data with the 3D component model, or models that comprise a corresponding digital asset. Such association allows system 800 to function as a digital asset management system as described above. Thus, in certain embodiments, model generation authority 802 can be used to administer and to manage digital assets. In alternative embodiments, a separate server or computer system 812 can be configured to manage digital assets and to access and retrieve 3D component models stored in 3D component library 806.

Server 812 can be interfaced with a user interface that allows a user to access and manage digital assets. User interface 810 can comprise displays, keyboards, a mouse, and other user input and output devices configured to allow a user to interact with server 812 and to retrieve and manage 3D component models and digital assets.

Model generation authority 802 can be configured to render various views of a digital asset and to store them, e.g., in library 806 as well. Alternatively, the rendered views can be stored in a separate rendered views database 814. Thus, for example, user interface 810 and server 812 can also be configured to allow a user to retrieve rendered views, e.g., using identifiers generated as described above. In fact, server 812 can also be interfaced with an availability database 816 and/or a pricing database 818 such that user interfaced 810 and server 812 can be used to preview and purchase seating for events as described above.

Depending on the embodiment, server 812, rendered views database 814, availability database 816, and/or pricing database 818 can be part of system 800 or one or more of them can, for example, be part of a remote, third party system.

The term database as used in reference to various components comprising system 800 is intended to refer to the physical storage as well as the database application used to structure and retrieve information in the database.

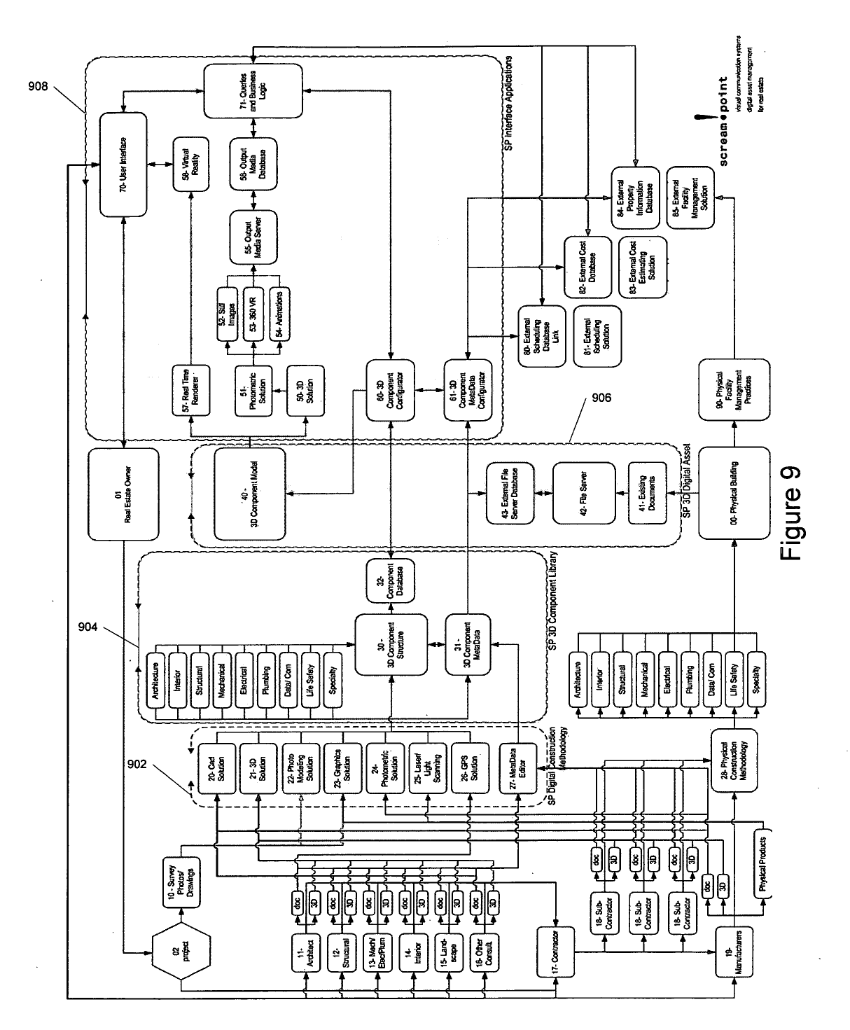

FIG. 9 is a diagram illustrating exemplary processes and integration technologies that can be used to create a full 3D model of a real estate property in accordance with one embodiment of the systems and methods described herein. For example, the processes and technologies illustrated in FIG. 9 can be provided or hosted, at least in part, by system 800.

Thus, digital construction methodologies 902, 3D component library 904, 3D digital asset 906, and interface applications 908 can all be provided, or hosted by the various components comprising system 800. Real Estate Owner 01 can then represent an individual or organization that holds the ownership rights to the physical real estate property, i.e., the physical asset. Project 02 can be any new ground up real estate development or renovation/remodeling of existing real estate that requires planning, design, documentation and/or construction activities. Survey Photos/Drawings 03 can be any photographic record or drawing, whether generated manually or by computer that describes a physical space or property with precise measurements and records the specific settings of the photographic or measuring device. This can include traditional and digital cameras.

The process of constructing a digital asset can mirror the process of constructing the physical asset, which is illustrated in the lower half of FIG. 9, with various results, outputs, etc. of the physical construction process serving as inputs to the digital construction process.

Various software applications can then be used to perform the integration methodologies, illustrated as part of digital construction methodologies 902, in order to generate geo-positioned, unique 3D components as described herein. For example as mentioned above various CAD solution 20, 3D modeling solution 21, photo modeling solution 22, graphics solutions 23, photometric solution 24, Laser/light scanning solutions 25, GPS solution 26, and MetaData editing solutions can, for example, be used.

Again as mentioned above, the input and processes can be combined to develop a 3D digital library 904 of real world based real estate components. 3D component library 904 can comprise 3D component structures 30, 3D component MetaData 31 and a component database 32.

3D digital asset 906 comprises the digital equivalent to the physical asset that real estate owner 01 owns. It is the specific and unique collection of objects and data that describes a particular property. 3D digital asset 906 can be maintained along side the physical asset 00, and can comprise components that look and behave much like their physical counterparts, but because of the components ability to be linked to critical data, the 3D digital asset 906 is in many ways ‘smarter’ and potentially more valuable than the physical asset.

3D digital asset 906 can, as illustrated and described above, comprise 3D component model 40, existing documents 41, e.g., existing CAD or manually generated documents that are or were being used in the planning, design, construction and operation process of a physical real estate project, file server 42, e.g., certain servers where existing documents 40 are stored/hosted and external file server database 43, e.g., a database solution, such as SQL, Oracle or ODBC, that manages the files stored on file server 41.

Interface applications 908 can then be used to both input information and to output data and images representing the digital asset or various aspects thereof. While certain embodiments of the inventions have been described above, it will be understood that the embodiments described are by way of example only. Other embodiments include but are not limited to applications in retail, residential, hospitality, commercial real estate, transportation, infrastructure and city operations. Accordingly, the inventions should not be limited based on the described embodiments. Rather, the scope of the inventions described herein should only be limited in light of the claims that follow when taken into conjunction with the above description and accompanying drawings.

1. A method for generating 3D component models, comprising:
generating a shell base component model;
generating a view base component model;
generating an event base component model;
creating a point identifier;
integrating the shell base component model, view base component model, and event base component model to generate the 3D component model and associating it with the identifier.

2. The method of claim 1, further comprising obtaining a plurality of architectural information and using the plurality of architectural information to generate the shell base component model, view base component model, and event base component model.

3. The method of claim 2, wherein obtaining a plurality of architectural information comprises obtaining as-built survey information.

4. The method of claim 2, wherein obtaining a plurality of architectural information comprises obtaining CAD drawings.

5. The method of claim 2, wherein obtaining a plurality of architectural information comprises obtaining drawings.

6. The method of claim 2, wherein obtaining a plurality of architectural information comprises obtaining architect information.

7. The method of claim 2, wherein obtaining a plurality of architectural information comprises obtaining structural information.

8. The method of claim 2, wherein obtaining a plurality of architectural information comprises obtaining at least one of mechanical, electrical, and plumbing information.

9. The method of claim 2, wherein obtaining a plurality of architectural information comprises obtaining interior information.

10. The method of claim 2, wherein obtaining a plurality of architectural information comprises obtaining landscape information.

11. The method of claim 2, wherein obtaining a plurality of architectural information comprises obtaining contractor information.

12. The method of claim 2, wherein obtaining a plurality of architectural information comprises obtaining manufacturer information.

13. The method of claim 2, wherein obtaining a plurality of architectural information comprises obtaining photographic images.

14. The method of claim 1, wherein generating a view base component model comprises obtaining images from a select viewpoint.

15. The method of claim 14, wherein obtaining viewpoint images comprises obtaining video images from a select viewpoint.

16. The method of claim 14, wherein obtaining viewpoint images comprises obtaining all spatial information that defines the location of the select viewpoint.

17. The method of claim 14, wherein obtaining viewpoint images comprises obtaining view path information associated with the select viewpoint.

18. The method of claim 13, wherein obtaining photographic images further comprises obtaining one accurate dimension for a venue being modeled.

19. The method of claim 1, further comprising obtaining event information and generating an event specific component model from the event information.

20. The method of claim 19, wherein obtaining event specific information comprises obtaining design and layout document for the setup of a specific event.

21. The method of claim 19, further comprising associating an event specific identifier with the event specific component model.

22. The method of claim 21, wherein generating an event specific component model further comprises generating a lighting specific component method.

23. The method of claim 21, wherein generating an event specific component model further comprises generating an acoustic specific component model.

24. The method of claim 1, further comprising generating a lighting base component model.

25. The method of claim 1, further comprising generating an acoustic base component model.

26. The method of claim 1, further comprising rendering a view base don the 3D component model.

27. The method of claim 26, further comprising storing the rendered view for retrieval using the identifier.

28. The method of claim 1, further comprising creating a shell base identifier, a view base identifier, and an event base identifier, and combining the shell base identifier, view base identifier, and event base identifier to create the identifier.

29. A method of previewing view points for a select event, comprising:
receiving a selection of an identifier identifying a select view point;
retrieving a rendered view associated with the identifier;
displaying the rendered view;
receiving an approval; and
updating a view point availability database in response to the received approval.

30. The method of claim 24 wherein receiving the identifier selection comprises receiving the identifier as input through a user interface.

31. The method of claim 29, wherein receiving the identifier selection comprises receiving the identifier selection from an interactive map.

32. The method of claim 31, wherein updating the view point availability comprises updating the interactive map to indicate that the view point is no longer available.

33. The method of claim 29, further comprising receiving a selection of an event associated with the view point.

34. A method of dynamically updating event pricing for a select event, comprising:
assigning a price to a plurality of view points related to the select event;
receiving a selection of identifier that identifies one of the plurality of view points;
displaying a rendered view associated with the selected identifier;
receiving an approval; and
updating the pricing based on the selection.

35. The method of claim 34, wherein updating the pricing comprises manually updating the pricing.

36. The method of claim 34, wherein the pricing is updated automatically.

37. The method of 34, further comprising receiving an event selection.

38. The method of claim 37, wherein the pricing is further updated based on the selected event.

39. A system for generating a 3D component model comprising a model generation authority configured to run a plurality of applications configured to allow the model generation authority to:
generate a shell base component model;
generate a view base component model;
generate an event base component model;
create an identifier; and
integrate the shell base component model, view base component model, and event base component model to generate the 3D component model and associate it with the identifier.

40. The system of claim 39, wherein the model generation authority is further configured to receive a plurality of architectural information and to generate the shell base component model, view base component model, and event base component model using the plurality of received architectural information.

41. The system of claim 40, wherein the plurality of architectural information comprises as-built survey information.

42. The system of claim 40, wherein the plurality of architectural information comprises CAD drawings.

43. The system of claim 40, wherein the plurality of architectural information comprises drawings.

44. The system of claim 40, wherein the plurality of architectural information comprises architect information.

45. The system of claim 40, wherein the plurality of architectural information comprises structural information.

46. The system of claim 40, wherein the plurality of architectural information comprises at least one of mechanical, electrical, and plumbing information.

47. The system of claim 40, wherein the plurality of architectural information comprises interior information.

48. The system of claim 40, wherein the plurality of architectural information comprises landscape information.

49. The system of claim 40, wherein the plurality of architectural information comprises contractor information.

50. The system of claim 40, wherein the plurality of architectural information comprises manufacturer information.

51. The system of claim 40, wherein the plurality of architectural information comprises photographic images.

52. The system of claim 1, wherein generating the view base component model comprises receiving a plurality of images associated with a select view point.

53. The system of claim 52, wherein the received view point images comprise video images.

54. The system of claim 52, wherein the received view point images comprise all spatial information that defines the location of the select view point.

55. The system of claim 52, wherein the received view point images comprise view path information associated with the select view point.

56. The system of claim 51, wherein the photographic images comprise one accurate dimension.

57. The system of claim 39, wherein the model generation authority is further configured to receive event specific information and to generate an event specific component model from the event specific information.

58. The system of claim 57, wherein the event specific information comprises design and layout document for the setup of a specific event.

59. The system of claim 57, wherein the model generation authority is further configured to associate an event specific identifier with the event specific component model.

60. The system of claim 59, wherein generating an event specific component model further comprises generating a lighting specific component model.

61. The system of claim 59, wherein generating an event specific component model further comprises generating an acoustic specific component model.

62. The system of claim 39, further comprising rendering a view based on the 3D component model.

63. The system of claim 62, further comprising storing the rendered view for retrieval using the identifier.

64. The system of claim 39, further comprising creating a shell base identifier, a view base identifier, and an event base identifier, and combining the shell base identifier, view base identifier, and event base identifier to create the identifier.

65. A system for previewing viewpoints for a select event, comprising:
user interface; and
a server configured to:
receive a selection of a viewpoint identifier associated with a select viewpoint,
render a 3D viewpoint model associated with the selected viewpoint identifier,
receive an approval of the viewpoint, and
update a viewpoint availability database in response to the received approval.

66. The system of claim 65, wherein receiving the viewpoint identifier comprises receiving the viewpoint identifier as input through the user interface.

67. The system of claim 65, wherein the user interface comprises an interactive map, and wherein receiving the viewpoint identifier comprises receiving a selection from the interactive map.

68. The system of claim 67, wherein updating the viewpoint availability comprises updating the interactive map to indicate that the viewpoint is no longer available.

69. The system of claim 65, wherein the server is further configured to receive a selection of an event.

70. The system of claim 65, wherein the server is further configured to assign a price to a plurality of viewpoints associated with a plurality of view point identifiers that includes the selected viewpoint identifier and update the pricing based on the selection of the viewpoint identifier.

71. The system of claim 70, wherein the pricing is updated automatically.

72. The system of claim 70, wherein the server is configured to receive manual pricing updates through the interface.

73. The system of claim 70, wherein the server is configured to receive an event selection through the user interface.

74. The system of claim 73, wherein the server is configured to update the pricing based on the selected event.
